(19) United States
(12) Patent Application Publication
(10) Pub. No.: US 2017/0228817 A1
(43) Pub. Date: Aug. 10, 2017

(54) ARRANGEMENTS AND METHODS FOR RENTING KAYAKS

(71) Applicant: Kenneth R. Brown, Queensbury, NY (US)

(72) Inventor: Kenneth R. Brown, Queensbury, NY (US)

(21) Appl. No.: 15/423,056

(22) Filed: Feb. 2, 2017

Related U.S. Application Data
(60) Provisional application No. 62/291,083, filed on Feb. 4, 2016.

(51) Int. Cl. G06Q 30/06; A47B 96/20; A47B 47/00; G06Q 20/20; A47B 81/00

(52) U.S. Cl. CPC G06Q 30/0645; G06Q 20/202; A47B 81/00; A47B 47/0041; A47B 96/20

(57) ABSTRACT

Storage arrangements for renting kayaks, paddle boards, and canoes and methods for renting kayaks and canoes are provided. The storage arrangements include a set of compartments. Each of the compartments in the set include elongated support members extending in a direction of elongation; perforated barriers extending between at least two of the elongated support members forming an opening at a first end, the opening adapted to receive a kayak or a canoe, and an opening at a second end of elongated support members; a barrier over the opening at the second end; and a displaceable cover mounted over the opening at the first end. In one aspect, the storage arrangement includes a mechanism adapted to releasably engage each of the plurality of compartments from an adjacent compartment. Methods for renting kayaks, paddle boards, and/or canoes are also provided.

### CROSS-REFERENCE TO RELATED APPLICATION

This application claims priority from pending U.S. Provisional Patent Application 62/291,083, filed on Feb. 4, 2016, the disclosure of which is included by reference herein in its entirety.

### BACKGROUND OF THE INVENTION

Technical Field

The present invention generally relates to arrangements and methods for remotely vending equipment. In particular, the present invention provides arrangements and methods for renting kayaks, and other equipment, using unmanned, remote point-of-sale stations and uniquely designed kayak storage arrangements having multiple compartments.

Description of Related Art

Kayakers in search of kayak rentals are typically presented with two problems: 1) kayak rentals are typically expensive (for example, $20-$30/hour or $50-$75/day at the time of this writing); and 2) kayak rentals typically have limited availability: often rental firms are not open for more than 6-8 hours during the day.

In addition, typically, the kayak rental industry has relied on manpower to rent kayaks. For example, a kayak rental firm typically employs one or more staff that simply accept payment from a renter and provide a kayak for the renter's use. The cost of this labor is borne by the kayak rental firm, and this cost is typically reflected in the cost of kayak rental.

Aspects of the present invention overcome or minimize these and other disadvantages of the prior art. For example, aspects of the invention can reduce the cost of kayak rental for the kayak renter, can increase the time of availability of kayak rentals, and also reduce or eliminate the cost of labor to kayak rental firms. These and other advantages and benefits of aspects of the present invention are presented below.

### SUMMARY OF THE INVENTION

Embodiments of the present invention, in their several aspects, overcome the disadvantages of the existing technology by providing point-of-sale stations and unique storage units or arrangements that can be unlocked based upon user input and purchase via the point-of-sale stations. The point-of-sale stations include software uniquely designed to present options and costs to the renter, to confirm the availability of the desired kayaks in the storage arrangement, and to unlock individual kayak storage compartments within the storage arrangement. Embodiments of the invention also include unique storage arrangements having specially-designed and adapted storage compartments configured to receive and dispense kayaks, and related equipment.

Accordingly, one embodiment of the invention is an elongated-vessel, for example, kayak, storage arrangement comprising or including a plurality of compartments, each of the plurality of compartments comprising: a plurality of elongated support members, each of the plurality of elongated support members extending in a direction of elongation; a plurality of perforated barriers, each of the plurality of perforated barriers extending between at least two of the plurality of elongated members forming an opening at a first end of the plurality of elongated members and an opening at a second end of the plurality of elongated members; a barrier over the opening at the second end; and a displaceable cover mounted over the opening at the first end. In one aspect, the displaceable cover comprises a rotatable door having a locking mechanism, for example, a remotely actuated locking mechanism. In one aspect, the plurality of perforated barriers each comprises fencing, for example, chain-link fencing.

In one aspect, the storage arrangement includes a mechanism adapted to releasably engage each of the plurality of compartments from an adjacent compartment. For example, the mechanism may comprise a plurality of brackets adapted to engage and disengage each of the plurality of adjacent compartments. At least some of the plurality of brackets may include a cavity adapted to receive one of the plurality of elongated members.

According to another aspect of the invention, the plurality of compartments further comprise a plurality of cross members, each of the plurality of cross members extending between two of the elongated support members and a plurality of uprights, each of the plurality of uprights extending between two of the elongated support members. In another aspect, each of the compartments comprises an aspect ratio greater than 3 to 1, or 5 to 1, or 10 to 1.

Another embodiment of the invention a method of storing a plurality of elongated vessels, for example, kayaks, the method comprising or including: providing a storage arrangement comprising a plurality of compartments, each of the plurality of compartments comprising a plurality of elongated support members, each of the plurality of elongated support members extending in a direction of elongation; a plurality of perforated barriers, each of the plurality of perforated barriers extending between at least two of the plurality of elongated members forming an opening at a first end of the plurality of elongated members and an opening at a second end of the plurality of elongated members; a barrier over the opening at the second end; and a displaceable cover mounted over the opening at the first end; opening the displaceable cover to provide access to at least one of the plurality of compartments; inserting an elongated vessel into the compartment; and closing the displaceable cover. In one aspect, the displaceable cover comprises a rotatable door having a locking mechanism, wherein the method further comprises unlocking the locking mechanism.

A further embodiment of the invention is a method of renting elongated vessels, the method comprising or including storing a plurality of elongated vessels, for example, kayaks, for rental to renters in a storage arrangement having a plurality of compartments, each of the compartments having a locking mechanism; providing a point-of-sale station configured for renter input and payment, the point-of-sale station electrically coupled to the storage arrangement; receiving input and, possibly, payment from the renter for one or more desired vessels; confirming presence of the one or more desired vessels in the storage arrangement; upon confirmation of payment from the renter, disengaging the locking mechanism allowing the renter to remove the one or more desired vessels from the storage arrangement. In one aspect, the point-of-sale station may be electrically coupled to the storage arrangement by wire or wirelessly. In another aspect, the method may further include identifying a location of the one or more desired vessels in the storage arrangement.

A still further embodiment of the invention is an arrangement for offering kayaks for rental, the arrangement comprising or including a storage arrangement comprising a plurality of storage compartments, each storage compartment adapted to receive at least one kayak and each storage compartment having a locking mechanism; and a point-sale-station electronically coupled to the storage arrangement, the point-of-sale station configured to receive input from a renter, configured to confirm availability of at least one kayak in the storage arrangement, and configured to disengage the locking mechanism. In one aspect, the arrangement may further include a power supply, for example, at least one photovoltaic panel. In another aspect, the storage arrangement may further include an audible or an illuminated beacon for use in identifying the location of the kayaks to be rented.

These and other aspects, features, and advantages of this invention will become apparent from the following detailed description of the various aspects of the invention taken in conjunction with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic perspective view of an arrangement for renting or vending kayaks or similarly sized equipment according to one aspect of the invention.

FIG. 2 is a schematic front elevation view of a point-of-sale station or “kiosk” shown in the arrangement in FIG. 1.

FIG. 3 is a detailed view of one display of the point-of-sale station shown in FIG. 2 according to an aspect of the invention.

FIG. 4 is a schematic block diagram of one system for operating aspects of the invention.

FIG. 5 is a partial front elevation view of one of the storage arrangements shown in FIG. 1 according to one aspect of the invention.

FIG. 6 is a view of the storage arrangement shown in FIG. 5 with an open compartment according to one aspect of the invention.

FIG. 7 is a partial front elevation view, similar to FIG. 6, of another storage arrangement shown with an open compartment according to one aspect of the invention.

FIG. 8 is a perspective view of a storage compartment according to one aspect of the invention.

FIG. 9 is a left-side elevation view of the storage compartment shown in FIG. 8, the right-side elevation view being a mirror image thereof.

FIG. 10 is a top plan view of the storage compartment shown in FIG. 8, the bottom view being a mirror image thereof.

FIG. 11 is an exploded perspective view of the storage compartment shown in FIG. 8.

FIG. 12 is a block diagram of a typical interaction of a customer with aspects of the invention.

FIG. 13 is a schematic representation of one of the displays a renter may observe on the display of the point-of-sale station shown in FIGS. 1 through 3.

FIG. 14 is a front perspective view of a portion of an arrangement for renting or vending kayaks or similarly sized equipment according to another aspect of the invention.

FIG. 15 is a rear perspective view of the portion of the arrangement shown in FIG. 14.

FIG. 16 is a top plan view of one top bracket shown in FIGS. 14 and 15 according to one aspect of the invention.

FIG. 17 is a side elevation view of the top bracket shown in FIG. 16.

FIG. 18 is a top plan view of a side bracket shown in FIGS. 14 and 15 according to one aspect of the invention.

FIG. 19 is a side elevation view of the side bracket shown in FIG. 18.

### DETAILED DESCRIPTION OF THE INVENTION

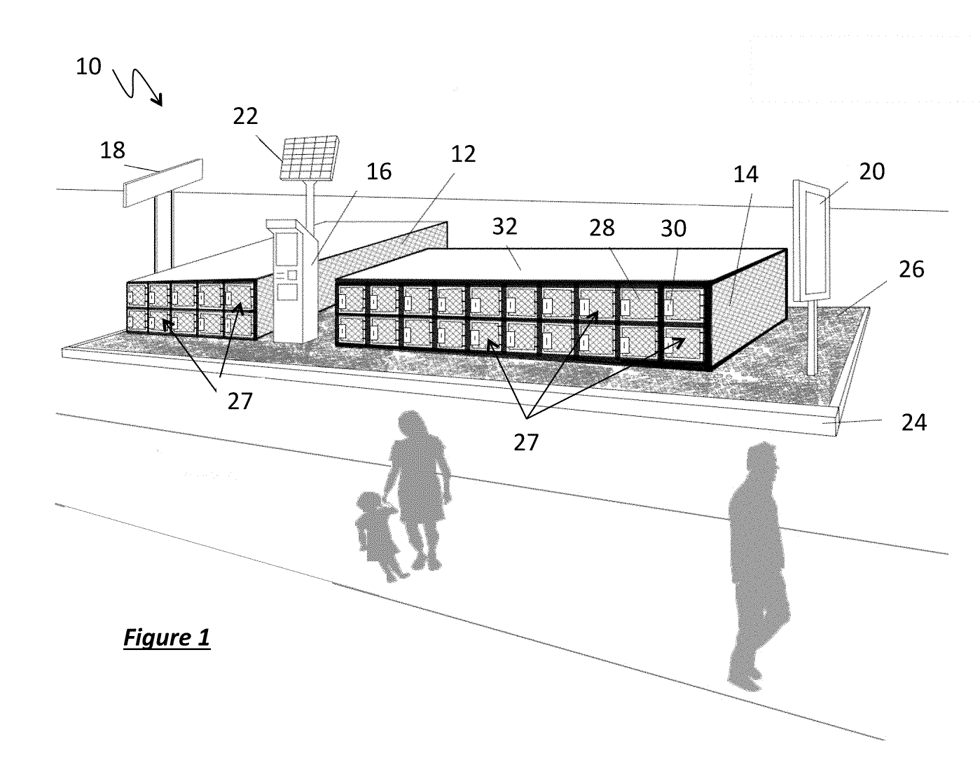

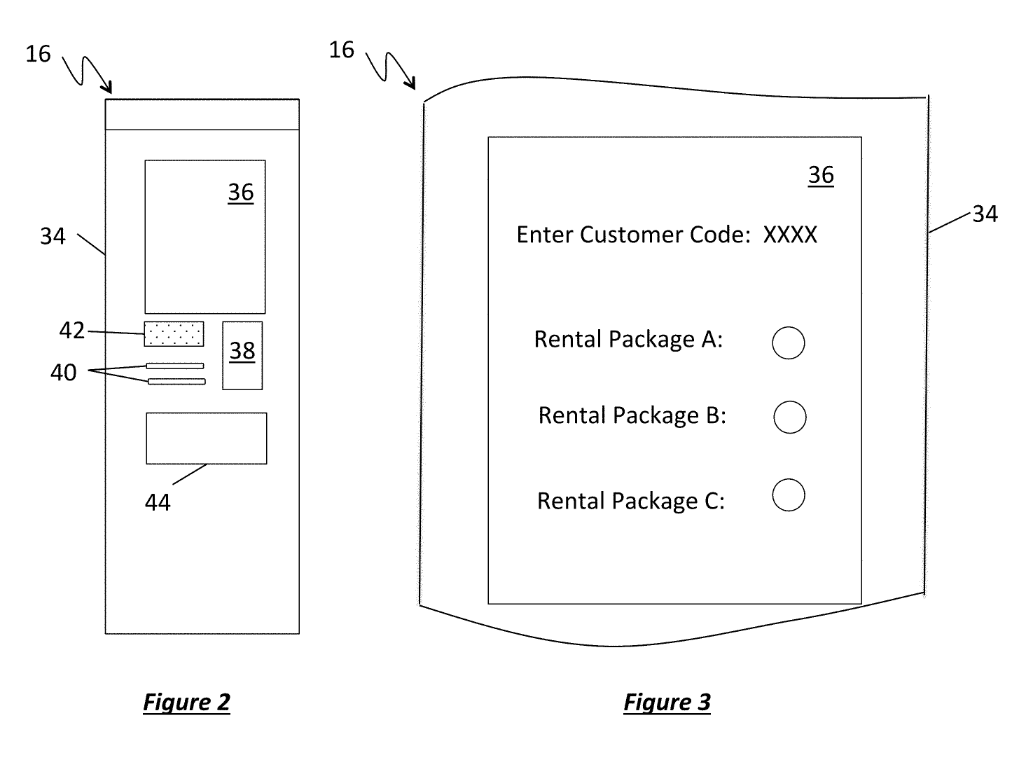

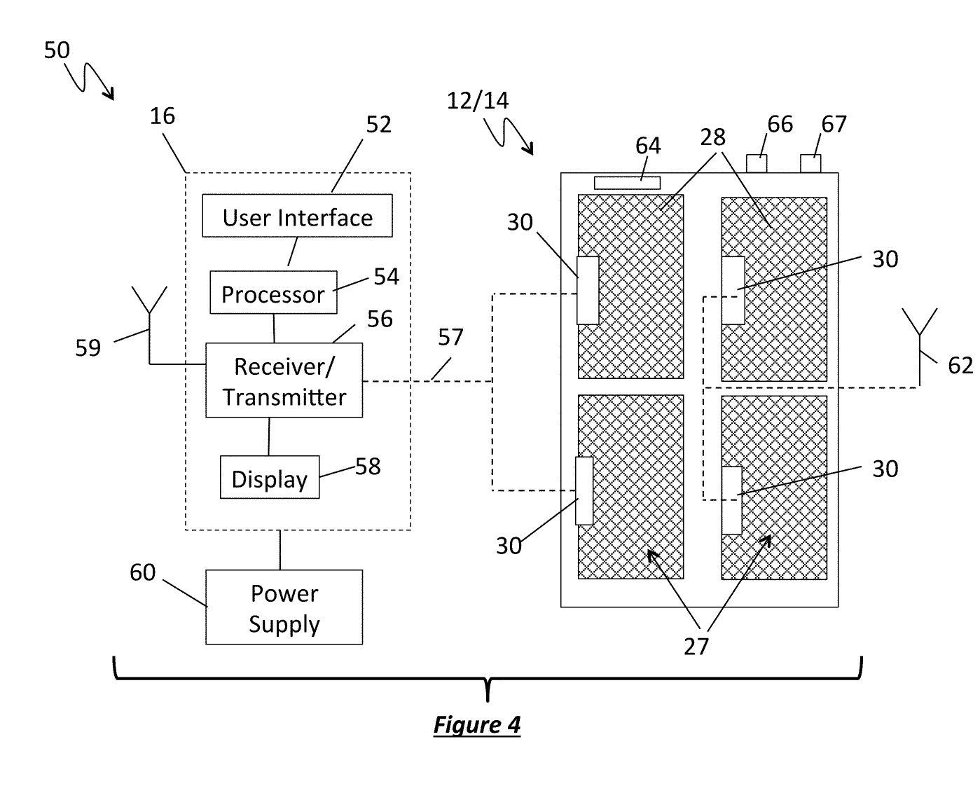

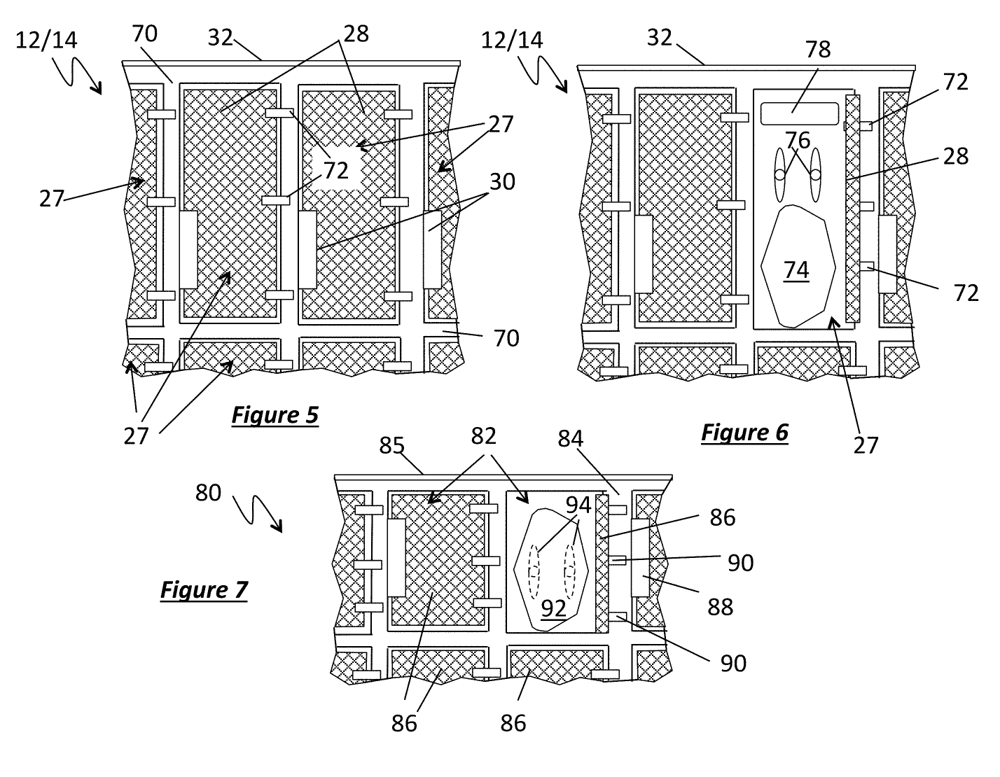

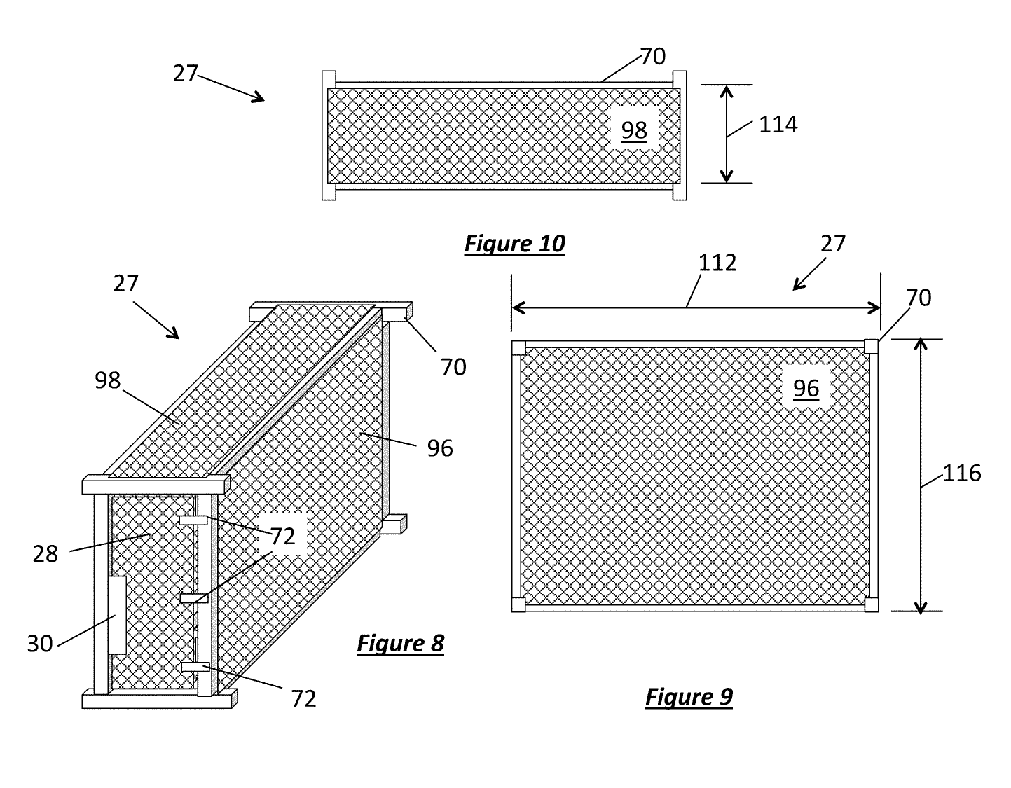

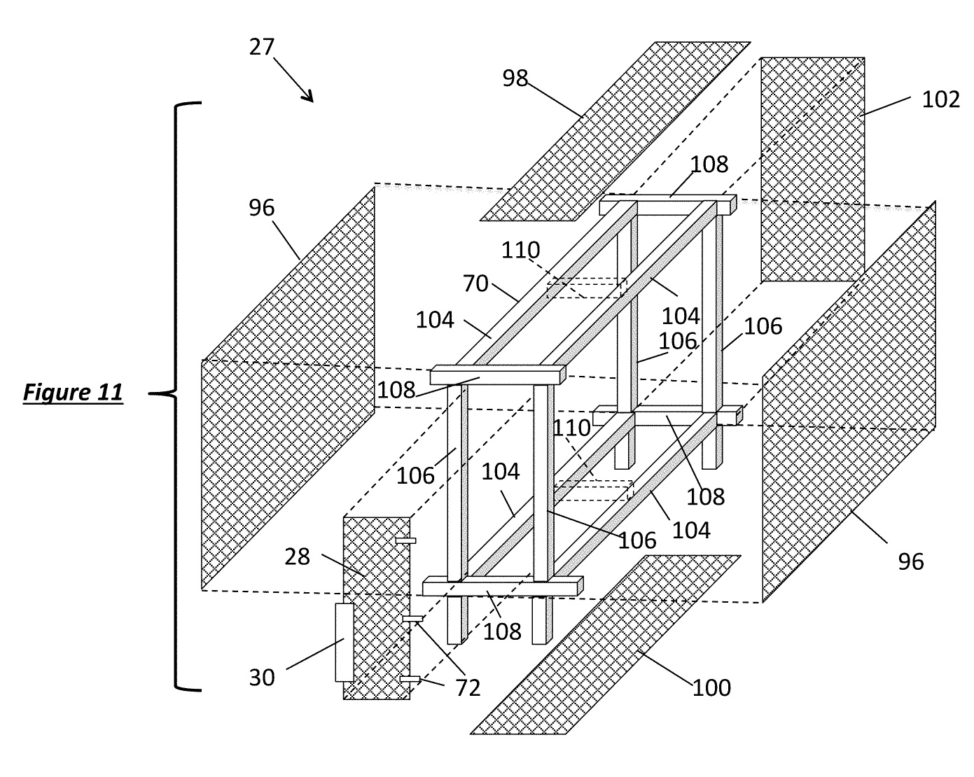

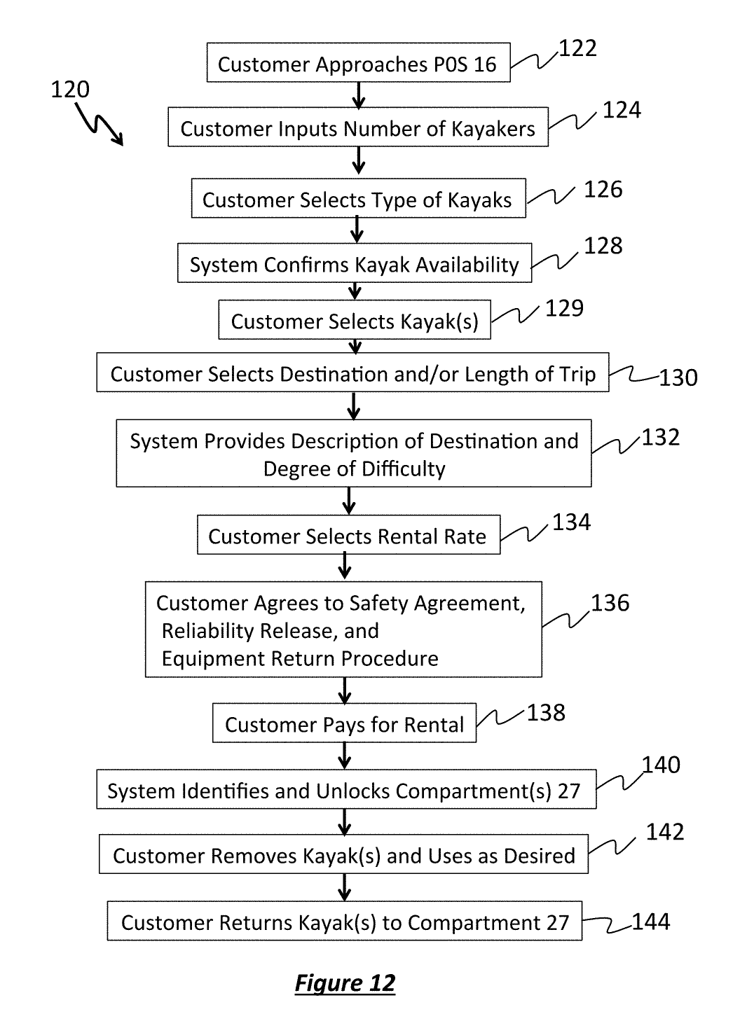

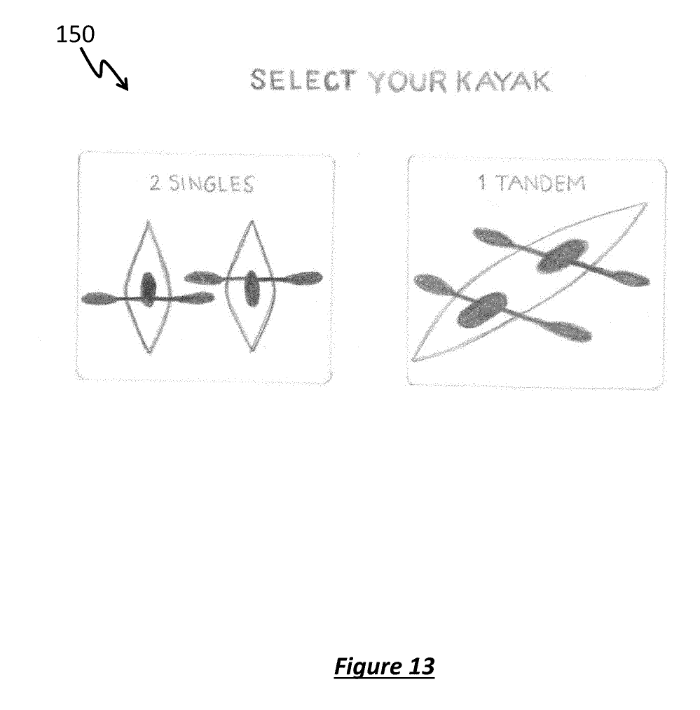

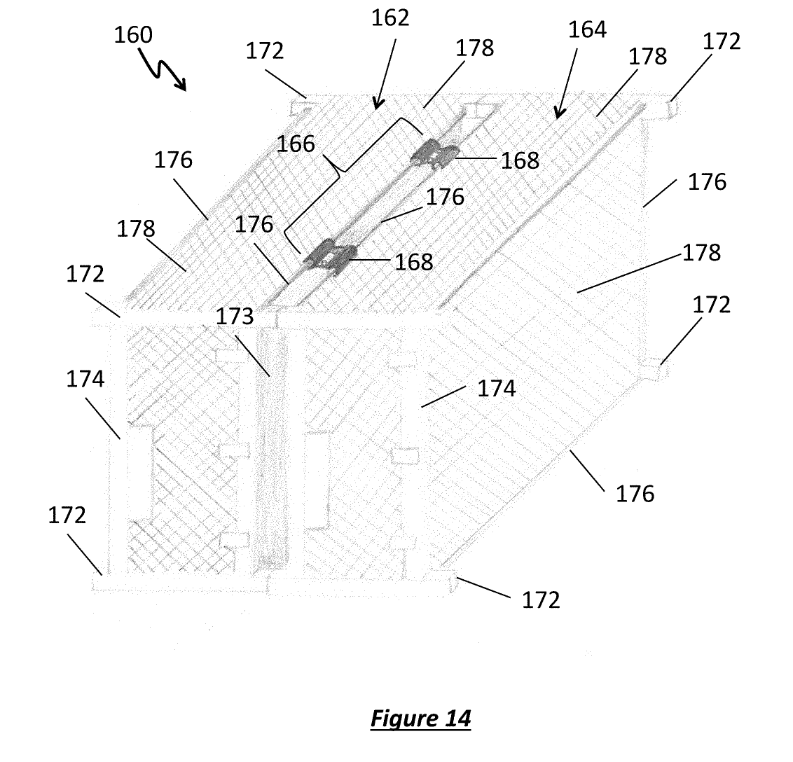

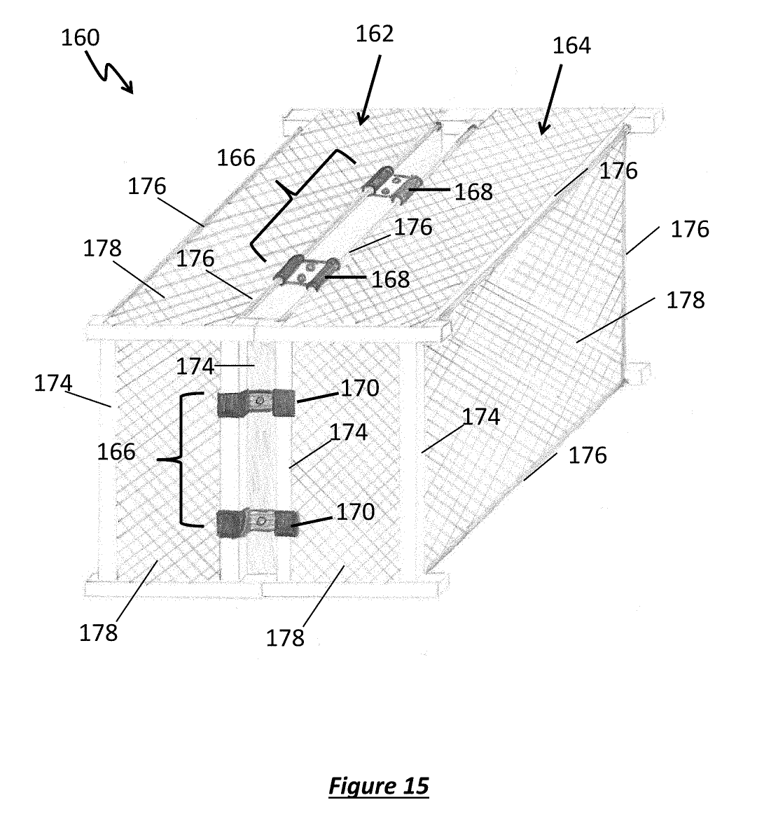

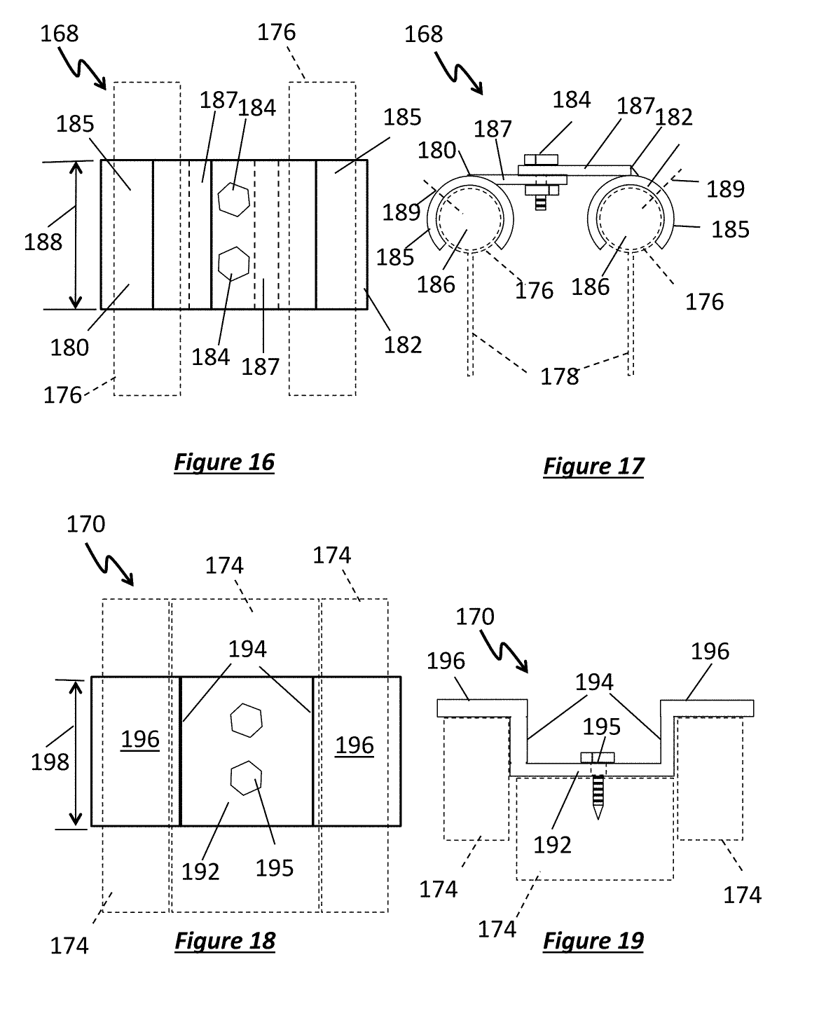

FIG. 1 is a schematic perspective view of an arrangement 10 for vending kayaks or similarly sized equipment according to one aspect of the invention. As shown in FIG. 1, arrangement 10 includes one or more storage units or arrangements 12 and 14, at least one point-of-sale (POS) station, or vending “kiosk,” 16, and assorted ancillary equipment. For instance, the ancillary equipment may include signage 18, displays 20, and power supplies 22, for instance, one or more arrays of photovoltaic panels. Arrangement 10 may also include appropriate landscaping, as desired, for example, a wood or timber frame 24 enclosing a ground treatment 26 of crushed stone, mulch, grass, groundcover, and the like.

As shown in FIG. 1, the one or more storage arrangements 12 and 14 may typically include a plurality of storage compartments 27 having access doors 28 typically equipped with locking mechanisms 30. Storage arrangements 12 and 14 may typically have a protective cover or roof 32, for example, to protect the contents of compartments 27 from weather, falling limbs, or exposure to the sun. Cover 32 may be metallic or non-metallic, for example, wooden or plastic.

According to aspects of the invention, arrangement 10 provides an advantageous approach to renting or vending kayaks, or other equipment, for example, without the need for personnel oversight or presence. As discussed in detail below, according to aspects of the invention, renters, customers, and/or purchasers may interface with kiosk 16 on site (or remotely) to rent or purchase equipment stored in storage arrangements 12 and 14. In one aspect, arrangement 10 may be located adjacent to a point of use of the kayaks or other equipment, for example, near a body of water, such as, a lake or a river, for example, at a remote location or in a heavily traveled resort or recreation area, or in a municipality, such as, a city waterfront, among other locations. According to aspects to of the invention, arrangement 10 provides convenient access to kayaks or other equipment at any time, for example, around the clock, early in the morning, or early in the evening, for instance, when rental personnel are typically not available or equipment renters are closed or will soon close.

In the following discussion, the term “kayak” or “kayaks” may be used to refer to the equipment stored, rented, and/or vended from storage arrangements 12 and 14 to facilitate disclosure of the many aspects of the invention. However, it is envisioned that a broad range of equipment, including sporting goods, camping equipment, tools, medical supplies, food, water, garments, clothes, firearms, or other items may be stored, rented, and/or vended by aspects of the invention. The equipment that may be stored and vended may include, but is not limited to, boats, canoes, skis (water and snow), snow shoes, snowboards, surfboards, paddle boards, standup paddle boards, skate boards, long boards, tents, backpacks, walking or hiking poles, fishing poles, fishing tackle, fishing bait, beach umbrellas, chairs, towels, and toys, among other items.

The storage arrangements 12 and 14 shown in FIG. 1 may comprise any number and size of compartments 27 in a broad range of configurations, from 2×2 configurations of compartments to 3×20 and 4×100. For example, as shown in FIG. 1, storage arrangement 12 comprises a 2×5 arrangement of compartments 27 and storage arrangement 14 comprises a 2×10 arrangement of compartments 27. It is envisioned that the configuration of compartments 27 in arrangements 12 and 14 and sizes of individual compartments 27 may vary broadly, for example, based upon the size and number of kayaks (or other equipment) stored in arrangements 12 and 14.

FIG. 2 is a schematic front elevation view of a point-of-sale (POS) station or “kiosk” 16 shown in the arrangement 10 shown in FIG. 1. The structure and appearance of kiosk 16 may be conventional. According to aspects of the invention, kiosk 16 provides hardware and software uniquely adapted to providing a user interface for renting or vending kayaks stored in storage arrangements 12 and 14. For example, as is typical of the art, kiosk 16 incudes a housing 34, and housing 34 may contain a display 36, for instance, an interactive display, a keyboard or keypad 38 for user input, one or more slots 40 for user input (of currency or credit cards) or dispensing receipts, a speaker 42 for receiving verbal commands and/or providing feedback to the user, and a drawer or compartment 44 for dispensing tokens, coins, currency, keys, receipts, or other items.

FIG. 3 is a detailed view of one display 36 of the POS station 16 shown in FIG. 2 according to an aspect of the invention. Display 36 may be an interactive display, for example, responsive to touch by a user, or may display information or options in response to input from a separate user input, for example, from keyboard 38. As shown in FIG. 3, display 36, may be configured to prompt the user for information, for example, name, address, and/or “customer code,” and may present a series of predefined typical “rental packages,” among a broad range of user input and system output. Other inputs and outputs that may be used may reflect the nature of the equipment being rented or vended, and will be readily apparent to those of skill in the art. Further examples of typical displays, and the functionality the displays represent, that may appear on display 36 are presented in FIG. 13.

FIG. 4 is a schematic block diagram of one system 50 for operating aspects of the invention. As shown in FIG. 4, system 50 typically comprises a series of components, for example, user input devices and processors, adapted to interface with a renter or customer and with the storage arrangements 12 and/or 14, for example, interface with the locking mechanisms 30 of arrangements 12 or 14. The components of system 50 may be contained in kiosk 16, as shown, or may be associated with storage arrangement 12 or 14, or may be off-site, for example, available via the Internet, that is, in “the cloud.”

In one aspect, system 50 typically includes one or more user interfaces 52, one or more processors 54, one or more receivers/transmitters 56, and one or more displays 58, among other devices. User interface 52 may be a touch screen, keyboard, keypad, stylus, mouse-type device, or voice-activated device. Processor 54 may be any conventional processor or central processing unit configured or programed to receive user input from interface 52, echo information on display 58, and forward data or control signals to storage arrangement 12 or 14 via receiver/transmitter 56. Transmitter/receiver 58 may be any device adapted to receive electrical signals, for example, wirelessly, or by wire, and with or without modifying the signals or the information contained in the signals, transmit signals, for example, wirelessly or by wire 57. The wired and wireless signals may be received and transmitted by any conventional wired protocol, for example, USB, HTMI, Cat 5, and the like, or by any conventional wireless protocol, for example, via Wi-Fi, Bluetooth, and the like, for example, via antenna 59. Display 58 may be any conventional display, for example, display 36 shown in FIG. 3, or signage 18 or display 20 shown in FIG. 1, and the like. As also shown in FIG. 4, system 50 may include one or more power supplies 60 within or outside of kiosk 16, for example, a connection to the local electrical grid, a photovoltaic array or panel (such as, photovoltaic panel 22 in FIG. 1), one or more batteries, a gas or propane generator, or a wind turbine, and the like.

As shown in FIG. 4, receiver/transmitter 56 may interface with storage arrangements 12 or 14 via wire 57 or wirelessly via antenna 59 and antenna 62. According to aspects of the invention, receiver/transmitter 56 may interface with a range of devices in, on, or near storage arrangements 12 and 14, for example, with one or more displays 64 or with one or more audible or visual beacons 66, for instance, identifying a storage compartment containing an available or rented kayak. In another aspect, receiver/transmitter 56 may interface with a locking mechanism 30 associated with each door 28. For example, in one aspect, based upon user input, processor 54 via receiver/transmitter 56 may unlock or disengage a previously locked locking mechanism 30, for instance, providing access to a renter to the contents in the compartment 27 unlocked. In another aspect, locking mechanism 30 may be initialized to accept a key dispensed by kiosk 16, or a pass code generated by processor 54 that can be entered on a keyboard or keypad associated with arrangement 12 or 14, or a QR code dispensed by kiosk 16 and scanned at or near locking mechanism 30 wherein locking mechanism 30 is unlocked. Other methods and criteria for unlocking locking mechanism 30 are envisioned and will be apparent to those in the art.

In one aspect of the invention, system 50 may sense or communicate with a detector or transponder associated with the kayaks stored in storage arrangement 12 or 14. For example, station 16 and/or storage arrangement 12 and/or 14 may include a detector or sensor 67 adapted to detect or sense the presence of a tag or transponder mounted in or on a kayak, for example, a radio frequency identification (RFID) tag or similar tag. In one aspect, a RFID tag may be used to determine the presence of a kayak for rental and/or the return of a kayak by a renter to the storage arrangement 12 or 14, wherein the rental transaction is completed.

FIG. 5 is a partial front elevation view of one of the storage arrangements 12 or 14 shown in FIG. 1 according to one aspect of the invention. As shown, storage arrangement 12 or 14 may comprise a plurality of compartments 27 defined by a structure 70, the structure 70 supporting a plurality of doors 28 having locking mechanisms 30. Doors 28 may be pivotally mounted to structure 70 by hinges 72. In one aspect, structure 70 may comprise a protective or decorative fascia concealing a support stature, for example, see structure 70 shown in FIG. 11. The size of compartments 27 and doors 28 may vary depending upon the size of the kayaks, or other equipment, stored in arrangements 12 and 14.

Locking mechanism 30 may comprise any conventional combination, keyed, or keyless locking mechanisms mounted to doors 28 and/or structure 70 to provide selective access to compartments 27. In one aspect, locking mechanism 30 may comprise an electronic locking mechanism adapted to respond to a signal transmitted by kiosk 16, for example, a signal transmitted by receiver/transmitter 56 via wire, for example, wire 57 in FIG. 4, or wirelessly. It is also envisioned that locking mechanism 30 may comprise or include some form of receiver adapted to detect a transponder or tag, for example, an RFID transponder or RFID tag, carried or presented by a renter. The transponder or tag may be issued by kiosk 16, for example, to compartment 44, upon completion of rental, the transponder or tag associated with one or more compartments 27. Upon detection of the appropriate transponder by the receiver, locking mechanism 30 may unlock or prompt the renter for a code, for example, a digital code, prior to unlocking.

FIG. 6 is a front elevation view of the storage arrangement 12 or 14 shown in FIG. 5 with an open compartment 27 according to one aspect of the invention. According to this aspect, a door 28 may typically be rotated about hinges 72 to provide access to the contents of compartment 27. For example, in the aspect shown, compartment 27 may containing a kayak 74, two oars 76, and one or more personal flotation devices (PFD) 78, though compartment 27 may contain other equipment.

FIG. 7 is a partial front elevation view, similar to FIGURES 5 and 6, of another storage arrangement 80 shown with an open compartment 82 according to another aspect of the invention. As shown, in this aspect, storage arrangement 80 may comprise a plurality of compartments 82 defined be a structure 84 having a roof or cover 85, the structure 84 supporting a plurality of doors 86 having locking mechanisms 88. Doors 86 may be pivotally mounted to structure 84 by hinges 90. According to this aspect, compartments 82 may be smaller than compartments 27. Doors 86 may typically be rotated about hinges 90 to provide access to the contents of compartments 82. For example, in the aspect shown, smaller compartment 82 may contain a kayak 92 and two oars 94 (shown in phantom) positioned within kayak 92. Again, compartments 82 may contain other equipment.

FIG. 8 is a perspective view of a storage compartment 27 that may be used in storage arrangement 12 or 14 according to one aspect of the invention. FIG. 9 is a left-side elevation view of storage compartment 27 shown in FIG. 8, the right-side elevation view being a mirror image thereof. FIG. 10 is a top plan view of storage compartment 27 shown in FIG. 8, the bottom view being a mirror image thereof. FIG. 11 is an exploded perspective view of storage compartment 27 shown in FIG. 8. Storage compartment 27 shown in FIGS. 8 through 11 is one of many typical compartments that may be used to provide storage arrangement 12 or 14 according to aspects of the invention. For example, storage compartment 27 shown in FIGS. 8 through 11 may comprise one of a series of adjacent compartments above, below, or to either side of storage compartment 27 shown in FIGS. 8 through 11.

As shown in FIGS. 8 through 11, storage compartment 27 is defined be a structure 70, and structure 70 supports at least one door 28 having a locking mechanism 30. Door 28 may typically be pivotally mounted to structure 70 by hinges 72. As also shown in FIGS. 8 through 11, storage compartment 27 typically includes a pair of opposing side panels 96, a top panel 98, a bottom panel 100, and an end panel 102 opposite door 28. Opposing side panels 96, top panel 98, bottom panel 100, and end panel 102 may typically all be mounted to structure 70 by conventional means, for example, with mechanical fasteners, welding, or an adhesive. In one aspect, one of more of side panels 96, top panel 98, bottom panel 100, and end panel 102 may be displaceable or rotatable to permit access to the interior of storage compartment 27. For example, end panel 102 may be hinged to structure 70 to permit access to compartment 27, for instance, by maintenance or service personnel.

As shown most clearly in FIG. 11, structure 70 may be fabricated with elongated members by conventional means. Structure 70 may comprise a plurality of elongated support members 104, for example, three or more support members 104; a plurality of uprights 106 extending between support members 104, and a plurality of cross members 108 extending between support members 104. Structure 70 may also include one or more cross members 110 (shown in phantom in FIG. 11) as needed for structural support or to provide support for a kayak. Support members 104, uprights 106, and cross members 108 (and 110) may comprise any structural material, for example, wood, steel, aluminum, or titanium, among other structural materials. In addition, support members 104, uprights 106, and cross members 108 (and no) may comprise any appropriate structural shape, for example, rectangular beams (as shown), tubing (circular, rectangular, or square), pipes, angle iron, I-beams, posts, rods, bars, and the like. In one aspect, support members 104, uprights 106, and cross members 108 (and 110) may comprise lumber, for example, wooden 2×45 or 2×65 and the like. In one aspect, support members 104, uprights 106, and cross members 108 (and 110) may comprise metallic tubing, for example, tubing typically used for “chain-link fencing,” for example, galvanized steel fence tubing.

Door 28, side panels 96, top panel 98, bottom panel 100, and end panel 102 may comprise any appropriate barrier adapted to prevent access to the inside of compartment 27. In one aspect, door 28, side panels 96, top panel 98, a bottom panel 100, and end panel 102 may comprise a substantially solid, unperforated barrier, for example, a plate, a board, or other panel. However, in another aspect, door 28, side panels 96, top panel 98, bottom panel 100, and end panel 102 may each comprise a perforated barrier, for example, a barrier that allows at least some visual inspection of the contents of compartment 27. Accordingly, in one aspect, door 28, side panels 96, top panel 98, bottom panel 100, and end panel 102 may comprise a plate or a board having a plurality of perforations or holes. In another aspect, door 28, side panels 96, top panel 98, bottom panel 100, and end panel 102 may comprise fencing, for example, chain-link fencing, “chicken wire,” wire netting, or wire-mesh fence, and the like. For example, in one aspect, door 28, side panels 96, top panel 98, bottom panel 100, and end panel 102 may comprise steel or plastic-coated steel fencing. In one aspect, one of more of door 28, side panels 96, top panel 98, bottom panel 100, and end panel 102 may be a solid material and one or more of door 28, side panels 96, top panel 98, a bottom panel 100, and an end panel 102 may be a perforated material. For example, in one aspect, door 28 may be a solid panel and side panels 96, top panel 98, a bottom panel 100, and an end panel 102 may be perforated fencing.

Door 28, side panels 96, top panel 98, a bottom panel 100, and end panel 102 may be metallic, for example, steel or aluminum, or non-metallic, for example, plastic or wood. When the panels are made of plastic, the plastic may be a polyamide (PA), for example, nylon; a polyethylene (PE), both high-density polyethylene (HDPE) and low-density polyethylene (LDPE); a polyethylene terephthalate (PET); a polypropylene (PP); a polyester (PE); a polytetrafluoroethylene (PTFE); a polystyrene (PS); an acrylonitrile butadiene styrene (ABS); a polycarbonate (PC); or a polyvinylchloride (PVC); among other plastics.

In one aspect, door 28, side panels 96, top panel 98, a bottom panel 100, and end panel 102 may be perforated or unperforated metallic or plastic sheets or boards. In anther aspect, door 28, side panels 96, top panel 98, a bottom panel 100, and end panel 102 may be metallic and/or non-metallic fencing, for example, metallic and/or non-metallic chain-link fencing, and the like.

As noted above, storage compartment 27 may comprise one of a series of adjacent compartments 27 above, below, or to either side of storage compartment 27 shown in FIGS. 8 through 11. Accordingly, it is envisioned that one or more components of storage compartment 27 may be shared or common to an adjacent compartment 27. For example, according to aspects of the invention, a laterally adjacent compartment 27 may share a side panel 96 and/or support members 104 and/or uprights 106; or a lower compartment 27 may share bottom panel 100 and/or support members 104 and/or cross members 108; or an upper compartment 27 may share top panel 98 and/or support members 104 and/or cross members 108.

According to aspect of the invention, compartment 27 shown in FIGS. 8 through 11 may be uniquely adapted to store elongated equipment, for example, one or more kayaks. For example, as shown most clearly in FIGS. 9 and 10, compartment 27 may comprise a depth 112 exceeding both a width 114 and a height 116. For example, according to aspects of the invention, compartment 27 may typically comprise an “aspect ratio,” that is, a ratio of depth 112 to width 114 of greater than 3-to-1, but typically greater than 5-to-1, for example, about 10 to 1. For example, in one aspect of the invention, depth 112 may range from about 3 feet to about 20 feet, but depth 112 may typically range from 10 feet to about 15 feet, for instance, about 14 feet. In one aspect, width 114 may range from about 1 foot to about 10 feet, but width 114 may typically range from 1 foot to about 4 feet, for instance, about 2 feet. In one aspect, height 116 may range from about 6 inches to about 10 feet, but height 116 may typically range from 1 foot to about 3 feet, for instance, about 2 feet.

FIG. 12 is a block diagram 120 illustrating a typical interaction of a customer, for example, a renter, with aspects of the invention. As shown in FIG. 12, a customer intending to rent, for example, rent one or more kayaks or canoes, may typically approach 122 a point-of-sale kiosk according to aspects of the invention, for example, kiosk 16 as disclosed herein. In the following discussion, the vessel to be rented will be referred to as “a kayak” or “kayaks” to facilitate disclosure of the invention. However, the use of these terms in no way limits the type or number of vessels that may be sold or rented according to aspects of the invention, which may include kayaks, canoes, surfboards, wind surfboards, paddle boards, standup paddle boards, beach umbrellas, and the like, as disclosed herein.

With activation of the kiosk, for example, by interaction by the customer with an icon on a touch-screen monitor or insertion of a payment card, the monitor on the kiosk may typically query the customer to input the number of kayakers for which kayaks are desired 124, for example, 1, 2, 3, 4, or more kayakers. Next, as indicated at 126, the kiosk monitor may then query the customer to select the type of kayaks desired. FIG. 13 presents a schematic representation 150 of one of the displays a customer may observe on the display of the point-of-sale station 16 shown in FIGS. 1 through 3 for input of the type of kayaks desired. The customer may be offered a selection of one or more “single” kayaks, one or more “tandem” kayaks, or a combination thereof. The appearance of schematic display 150 may be typical of other displays that may be displayed on the monitor provided according to aspects of the invention.

As further indicated on FIG. 12, the system and/or software according to aspects of the invention, after reviewing the available inventory (for example, as detected by detector or sensor 67 shown in FIG. 4), may then echo to the renter the number and types of kayaks that are available 128, for the customer's selection 129.

After selection of the kayaks desired 129, the customer may then be queried to select the desired destination and/or length of trip 130. For example, the customer may be offered options of destinations, such as, nearby streams, nearby lakes, a nearby bay, or a nearby harbor, among other destinations. Also, the customer may be offered the option of set periods of rental, for example, a “half day” (for example, 4 hours) rental, a “full day” (for example, 8 hours) rental, enter specific number of hours and/or minutes of rental time, or a specific start and end time for rental, as desired.

The systems, methods, and/or software of aspects of the invention may query the customer with a selection of available courses of travel or destinations for kayaking 132. This offering may indicate a degree of difficulty of the course or destination, for example, from “novice,” to “intermediate,” to “advanced,” and/or to “extreme,” among other descriptors of degree of difficulty of the course or destination.

As further indicated in FIG. 12, based, for example, upon the number of kayakers, number of kayaks, type of kayak, course or destination, and/or desired length of rental, aspects of the invention may identify and the customer may select 134 the rental cost on the monitor of the kiosk; for example, a 1-hour rate, a 2-hour rate, a 3-hour rate, a half-day rate, a full-day rate, and/or multiple day rate, such as, a weekly, a monthly, and/or a yearly rate.

As indicated at 136, aspects of the invention may also present one or more safety agreements, one or more reliability releases, and/or one or more equipment return procedures to the customer for information, selection, and/or agreement.

Upon confirmation of the appropriate agreements, releases, and/or procedures 136, the customer may then be offered a payment screen on the monitor to select and pay for the rental 138. Payment options may include cash, credit or debit card, PayPal, prepaid tokens or cards, and/or other conventional payment methods.

When payment is received and approved, for example, via an external credit or debit card provider system, the systems, methods, and/or software of aspects of the invention may then identify the location of the rented kayaks 140, for example, in one or more compartments 27, as disclosed herein. The identification may be practiced by means of an alphanumeric identifier displayed on the monitor, via an audible signal proximate the one or more compartments, via a visual signal proximate the one or more compartments, or a combination thereof. In one aspect, with identification of the location of the kayak available for rental, the one or more compartments 27 may be unlocked for customer access, for example, via locking mechanism 30. Accordingly, the customer may then remove the one or more kayaks, and any associated equipment 142, such as, paddles, oars, and/or life jackets, among other things, from one or more compartments 27.

After use and enjoyment of the one or more kayaks, and/or the associated equipment, by the customer, aspects of the invention allow the customer to return the kayaks 144, for example, to one or more compartments 27. The location of the compartments 27 may be the same or different from the compartments from which the rented kayaks were taken. Aspects of the invention may include the identification of the appropriate compartment for return, for example, after the customer accesses the kiosk and enters, for example, a user name/password and/or other identifier. For example, upon entry of an identifier, aspects of the invention may identify the one or more compartments to which the kayaks are to be returned by means of a alphanumeric identifier, an audible signal proximate the one or more compartments, a visual signal proximate the one or more compartments, or a combination thereof.

Upon return of the kayaks, and/or associated equipment, to the one or more compartments 27, the one or more compartments may be locked, for example, via locking mechanism 30, to prevent unauthorized access to the kayaks. In one aspect, upon return and locking of the compartments, the customer may be issued a receipt, for example, from kiosk 16 or via email, confirming return of the kayaks.

According to aspects of the invention, arrangement 10 shown in FIG. 1 having kiosk 16 and one or more storage arrangements 12 or 14 provide the following methods for renting and/or vending a kayak, or other equipment. First, the kayak rental firm will typically store a plurality of kayaks for rental to customers in a storage arrangement 12 and/or 14, that is, in the plurality of compartments 27 each having a locking mechanism 30, and then engage locking mechanisms 30 to prevent unauthorized removal. The kayak rental firm will also provide the point-of-sale station 16 that is configured for user input and payment.

As described herein, the point-of-sale station 16 is electrically coupled to the storage arrangement 12 and/or 14, for example, eclectically coupled to locking mechanisms 30. The prospective kayak renter inputs user data and the desired number and type of kayak(s), among other input, into point-of-sale station 16. Once input, the system 50 (see FIG. 4) determines the availability of the desired kayak(s) in storage arrangement 12 and/or 14, for example, via RFID detection, and echoes the availability to the renter on display 36 of point-of-sale station 16. The renter then confirms the desired purchase (for example, including agreeing to, for example, a safety agreement, a reliability release, and/or a return procedure) and pays the appropriate rental fee (for example, via cash or credit card). Upon confirmation of payment from the renter, system 50 then disengages the locking mechanism 30 of the desired kayak(s) allowing the user to remove the one or more desired kayak(s), and paddles and PFDs, from storage arrangement 12 and/or 14.

In one aspect, system 50 may direct the renter to the appropriate storage compartment 27, for example, via a map, via an illuminated beacon adjacent the target compartment, and/or via an audible signal adjacent the target compartment. In one aspect, after removal of the desired kayak(s), the renter may use the vacated compartment 27 for storage and securing (via locking mechanism 30) of personal items while using the kayak(s).

It is envisioned that the renter may conduct the above procedure locally, that is, while on location at arrangement 10, or remotely, for example, via the Internet. For example, many of the above procedures may be practiced over the Internet, for example, entering renter information, confirming availability, and paying for rental, to reserve a kayak rental, and the transaction can be completed locally upon arrival at the site of arrangement 10. For example, a renter may only provide a confirmation code or user-name/password to the point-of-sale station 16 and then retrieve the previously reserved kayak(s) from arrangement 12 and/or 14. The renter may then use the rented kayak(s) as desired, for example, for the agreed upon time interval, and then return the rented kayak(s) to site 10.

Upon return of the kayaks, the renter may insert the returned kayak(s) to a compartment 27 of arrangement 12 and/or 14, for example, to the compartment 27 from which the kayak(s) were removed. System 50 (FIG. 4) may detect the return of the rented kayak(s), for example, via an RFID tag, and direct the renter to return the kayak(s) to a desired compartment 27, for example, via an audible or an illuminated beacon. When the kayak(s) are inserted in desired compartment 27 and the door 28 is closed and locking mechanism 30 engaged, system 50 may confirm return of the rented kayak(s), for example, via display 36 on kiosk 16 and/or by printing and dispensing a receipt from kiosk 16.

Alterations and modifications of this rental and return procedures will be apparent to those of skill in the art.

FIG. 14 is a front perspective view of a portion 160 of an arrangement for renting or vending kayaks or similarly sized equipment according to another aspect of the invention. FIG. 15 is a rear perspective view of the portion 160 of the arrangement shown in FIG. 14. As shown in FIGS. 14 and 15, the portion 160 may include at least 2 compartments 162 and 164 (for example, having all the attributes of compartment 27 disclosed herein) and, in this aspect, one or more mechanisms 166 adapted to releasably engage a first compartment 162 from an adjacent compartment 164. Portion 160 may be a portion of the arrangement 12 and/or 14 of compartments shown in FIG. 1. In addition, though compartments 162 and 164 shown in FIGS. 14 and 15 are laterally adjacent to each other, aspects of the invention are envisioned where compartments 162 and 164 may be vertically adjacent to each other, and include one or more mechanisms 166. For example, compartment 164 may be positioned vertically above or vertically below compartment 162 and be engageable by means of one or more mechanisms 166.

In the aspect of the invention shown in FIGS. 14 and 15 compartments 162 and 164 are fabricated from wood, fence tubing, and fencing, though other means of fabrication may be provided as disclosed herein. Specifically, compartments 162 and 164 are constructed from wooden cross members 172, wooden posts 173, wooden uprights 174, for example, wooden 2×4s, wooden 4×4s, and wooden 2×4s, respectfully. In addition, compartments 162 and 164 include elongated support members comprising fence tubing 176, and perforated barriers comprising plastic or metallic fencing 178, though other elongated members or perforated barriers may be used.

According to one aspect of the invention, any appropriate mechanisms 166 may be used to allow the engagement or disengagement of compartment 162 from compartment 164. In the aspect of the invention shown in FIGS. 14 and 15, mechanism 166 includes a plurality of brackets, specifically, a plurality of top brackets 168 and a plurality of side brackets 170. Though not shown in FIGS. 14 and 15, it is envisioned that similar top brackets 168 on the bottom and/or sides of compartments 162 and 164 may also engage compartments 162 and 164. Accordingly, though this disclosure of the invention may refer to bracket 168 as a “top bracket,” it will be understood that bracket 168 may comprise a “bottom bracket” or a “side bracket.” Similarly, though not shown in FIGS. 14 and 15, it is envisioned that compartments 162 and 164 may also be engaged by similar side brackets 170 on the bottom and/or top of compartments 162 and 164. Accordingly, though this disclosure of the invention may refer to bracket 170 as a “side bracket,” it will be understood that bracket 170 may comprise a “top bracket” or a “bottom bracket.”

FIG. 16 is a top plan view of one top bracket 168 shown in FIGS. 14 and 15 according to one aspect of the invention. FIG. 17 is a side elevation view of top bracket 168 shown in FIG. 16. As shown in FIGS. 16 and 17, top bracket 168 is typically adapted to receive elongated support members 176, for example, fence tubing, shown in phantom in FIGS. 16 and 17. A typical perforated barrier or fencing 178 is also shown in phantom in FIG. 17.

As shown in FIGS. 16 and 17, top bracket 168 may comprise a plurality of components, for example, a first clamp 180 and a second clamp 182 each adapted to engage fence tubing 176. Clamp 180 and clamp 182 may be a single integral structure or may one or more fasteners 184 releasably engage distinct structures. As shown most clearly in FIG. 17, clamp 180 and clamp 182 may typically each comprise one or more body portions 185 and one or more extension portions 187 each mounted to a body portion 185, for example, by welding, mechanical fasteners, or integrally formed, for example, by extrusion. As shown, body portion 185 typically includes a cavity 186 adapted, for example, sized and shaped, to receive an elongated member, upright, or beam 176 (shown in phantom). In the aspect of the invention shown in FIG. 17, cavity 186 is shown generally circular in cross section; however, according to aspects of the invention, cavity 186 may be non-circular or polygonal in cross section, for example, depending upon the shape and size of elongated member 176. For example, in one aspect, when elongated members 176 comprise rectangular tubing or wooden 2×4s, cavity 186 may be square or rectangular in cross section.

Extension portion 187 may comprise any structure or device adapted to engage one body portion 185 with another body portion 185. For example, extension portion 187 may comprise one or more plates, one or more bars, or one or more rods extending between one body portion 185 and another body portion 185. In the aspect shown in FIGS. 16 and 17, extension portions 187 comprise plates, for example, metal plates, for instance, carbon steel, stainless steel, or aluminum plates. Plates 187 may typically be mounted on body portion 185 by conventional means, for example, by welding, by an adhesive, and/or by mechanical fasteners. In the aspect of the invention shown in FIG. 17, plates 187 are generally horizontal in orientation; however, it is envisioned that plates 187 may be non-horizontal, for example, oriented an angle to the horizontal. In one aspect the angel of orientation to the horizontal of plates 187 may range from about 5 degrees to about 30 degrees from the horizontal, for example, as the horizontal is defined by the direction of elongation of members 176.

Clamp 180 and clamp 182 may be releasably engaged by any conventional means, for example, by one or more fasteners, for example, one or more mechanical fasteners. For example, in the aspect shown in FIGS. 16 and 17, clamp 180 and clamp 182 may be releasably engaged by threaded fasteners 184, for example, one or more bolts passing through one or more holes in extension portions 187 and one or more nuts. Other releasable fasteners will be apparent to those of skill in the art.

In one aspect, in addition to fastener 184 or in place of fasteners 184 (for example, when clamp 180 and clamp 182 comprise a single, integral device), bracket 168 may also engage elongated members 176 by one or more fasteners 189, for example, one or more threaded fasteners. As shown in FIG. 17, in this aspect, one or more fasteners 189 may penetrate at least one body portion 185 and engage elongated member 176 to releasably engage bracket 168 with elongated members 176 (or uprights 174).

Plates 187 may have a thickness ranging from bout ¼ inch to 3 inches, but are typically about ½ inch in thickness. Body portion 185 and extension portion 187 of clamps 180 and 182 may have a length 188 ranging from about ½ inch to about 3 feet, but typically, between about 3 inches and 12 inches in length, for example, about 6 inches in length.

FIG. 18 is a top plan view of a side bracket 170 shown in FIGS. 14 and 15 according to one aspect of the invention. FIG. 19 is a side elevation view of the side bracket 170 shown in FIG. 18. As shown in FIGS. 18 and 19, side bracket 170 is typically adapted to receive uprights 174, for example, wooden 2×4s, shown in phantom in FIGS. 18 and 19, and engage upright 174, for example, two wooden 2×45 or one wooden 4×4. In one aspect, the engagement of side bracket 170 with uprights 174 may assist in engaging compartment 162 to compartment 164, as shown in FIGS. 14 and 15.

As shown in FIGS. 18 and 19, side bracket 168 may comprise a plurality of portions, for example, a base portion 192, side portions 194, and lateral flange portions 196. Side bracket 168 may be a single integral structure or may comprise distinct structures engaged by welding, an adhesive, mechanical fasteners, or integrally formed, for example, by extrusion. As shown, side portions 194, and lateral flange portions 196 are adapted, for example, sized and shaped, to engage an elongated member, upright, or beam 174 (shown in phantom), and base portion 192 is adapted, for example, sized and shaped, to engage an elongated member, upright, or beam 174 (shown in phantom). In the aspect of the invention shown in FIG. 19, base portion 192, side portions 194, and lateral flange portions 196 are shown generally rectilinear in cross section (for example, having planar shapes); however, according to aspects of the invention, base portion 192, side portions 194, and lateral flange portions 196 may be non-rectilinear, circular, arcuate, or curved in cross section, for example, depending upon the shape and size of elongated members or uprights 174. For example, in one aspect, when uprights 174 comprise circular tubing or wooden dowels, base portion 192, side portions 194, and lateral flange portions 196 may be circular or arced in cross section.

Base portion 192, side portions 194, and lateral flange portions 196 may comprise any structure or device adapted to engage adjacent portions. For example, base portion 192, side portions 194, and lateral flange portions 196 may one or more plates, one or more bars, or one or more rods extending between one portion and another portion. In the aspect shown in FIGS. 18 and 19, base portion 192, side portions 194, and lateral flange portions 196 comprise plates, for example, metal plates, for instance, carbon steel, stainless steel, or aluminum plates. The plates of base portion 192, side portions 194, and lateral flange portions 196 may typically be attached to each other by conventional means, for example, by welding, adhesive, and/or mechanical fasteners. In the aspect of the invention shown in FIG. 19, base portion 192, side portions 194, and lateral flange portions 196 are generally horizontal and vertical in orientation; however, it is envisioned that base portion 192, side portions 194, and lateral flange portions 196 may be non-horizontal or non-vertical, for example, oriented an angle to the horizontal or vertical, respectively, for example, from about 5 degrees to about 30 degrees from the horizontal or vertical, for example, as the vertical as defined by the direction of elongation of uprights 174.

Side bracket 170 may releasably engage uprights 174 by any conventional means, for example, by one or more fasteners, for example, one or more mechanical fasteners. For example, in the aspect shown in FIGS. 18 and 19, side bracket 170 may releasably engage one or more uprights 174 by one or more threaded fasteners 195, for example, one or more wood screws passing through one or more holes in base portion 192 and engaging uprights 174. In a similar fashion, in addition to or instead of fasteners 195, side bracket 170 may also be releasably engage one or more uprights 174 by threaded fasteners (not shown), for example, one or more wood screws, passing through one or more holes in side portions 194 and/or lateral flange portions 196 and engaging uprights 174. Other releasable fasteners will be apparent to those of skill in the art.

Base portion 192, side portions 194, and lateral flange portions 196 may have a thickness ranging from about ¼ inch to about 3 inches, but are typically about ½ inch in thickness. Base portion 192, side portions 194, and lateral flange portions 196 of side bracket 170 may have a length 198 ranging from about ½ inch to 3 feet, but typically, between about 3 inches and 12 inches in length, for example, about 6 inches in length.

With this review of aspects of the invention it will be apparent that, according to aspects of the invention, one or more compartments 27 shown in FIG. 1 or one or more compartments 162 or 164 shown in FIGS. 14 and 15, for instance, comprising a portion 160 of the arrangement 12 and/or 14 of compartments shown in FIG. 1, may be selectively engaged and disengaged from adjacent compartments in an arrangement of compartments. For example, according to aspects of the invention, compartments 27, 162, and/or 164 may be selectively removed or added to arrangements 12 and/or 14 as the demand or need arises. For instance, according to one aspect of the invention, when a site 10 (see FIG. 1) having an arrangement 12 or 14 of compartments 27, 162, or 164 requires the addition of one or more additional compartments, for example, due to customer demand, one or more compartments 27, 162, or 164 may be disengaged from another site or location having an arrangement 12 or 14 of one or more compartments 27, 162, or 164 and moved to site 10 needing more compartments.

According to aspects of the invention, one or more compartments 27, 162, or 164 may be disengaged from an arrangement 12 or 14 by disengaging brackets 168 and 170, as disclosed herein, between adjacent compartments and then transporting the one or more disengaged compartments to the site requiring the disengaged compartments. Similarly, when the one or more disengaged compartments 27, 162, or 164 arrive at the desired location, the compartments 27, 162, or 164 can be installed, mounted, or otherwise engaged with an existing arrangement 12 or 14 to provide additional storage or rental space desired for kayaks, paddle boards, canoes, or related vehicles as disclosed herein.

Accordingly, as described above, methods and arrangements have been provided that overcome the limitations and disadvantages of the prior art. Specifically, among other advantages, aspects of the invention, can reduce the cost of kayak rental for the kayak renter, can increase the availability of kayak rentals, and can also reduce or eliminate the cost of labor for kayak rental firms. In addition, aspects of the invention provide methods and devices for disengaging and reengaging storage and/or rental compartments from compartment arrangements to address user needs, market demand, or operator desires, among other reasons.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While several aspects of the present invention have been described and depicted herein, alternative aspects may be affected by those skilled in the art to accomplish the same objectives. Accordingly, it is intended by the appended claims to cover all such alternative aspects as fall within the true spirit and scope of the invention.

1. A kayak, paddle board, or canoe storage arrangement comprising a plurality of compartments, each of the plurality of compartments comprising:
a plurality of elongated support members, each of the plurality of elongated support members extending in a direction of elongation;
a plurality of perforated barriers, each of the plurality of perforated barriers extending between at least two of the plurality of elongated support members forming an opening at a first end of the plurality of elongated support members, the opening in the first end adapted to receive a kayak or a canoe, and an opening at a second end of the plurality of elongated support members;
a barrier over the opening at the second end;
a displaceable cover mounted over the opening at the first end; and
a mechanism adapted to releasably engage each of the plurality of compartments from an adjacent compartment.

2. The storage arrangement as recited in claim 1, wherein the mechanism adapted to releasably engage each of the plurality of compartments comprises plurality of brackets adapted to engage and disengage each of the plurality of adjacent compartments.

3. The storage arrangement as recited in claim 2, wherein at least some of the plurality of brackets comprise a cavity adapted to receive one of the plurality of elongated members.

4. The storage arrangement as recited in claim 1, wherein the displaceable cover comprises a rotatable door having a locking mechanism.

5. The storage arrangement as recited in claim 4, wherein the locking mechanism comprises a remotely actuated locking mechanism.

6. The storage arrangement as recited in claim 1, wherein the plurality of perforated barriers each comprise fencing.

7. The storage arrangement as recited in claim 1, wherein the fencing comprises chain-link fencing.

8. The storage arrangement as recited in claim 1, wherein each of the plurality of compartments further comprises:
a plurality of cross members, each of the plurality of cross members extending between two of the elongated support members.

9. The storage arrangement as recited in claim 1, wherein each of the plurality of compartments further comprises:
a plurality of uprights, each of the plurality of uprights extending between two of the elongated support members.

10. The storage arrangement as recited in claim 1, wherein each of the compartments comprises an aspect ratio greater than 3 to 1.

11. A method of storing a plurality of kayaks, paddle boards, or canoes, the method comprising:
providing a storage arrangement comprising a plurality of compartments, each of the plurality of compartments comprising:
a plurality of elongated support members, each of the plurality of elongated support members extending in a direction of elongation;
a plurality of perforated barriers, each of the plurality of perforated barriers extending between at least two of the plurality of elongated members forming an opening at a first end of the plurality of elongated members and an opening at a second end of the plurality of elongated members;
a barrier over the opening at the second end;
a displaceable cover mounted over the opening at the first end; and
a mechanism adapted to releasably engage each of the plurality of compartments from an adjacent compartment
opening the displaceable cover to provide access to at least one of the plurality of compartments;
inserting the kayaks, paddle boards, or canoes into the compartment; and
closing the displaceable cover.

12. The method as recited in claim ii, wherein the method further comprises engaging at least two of the plurality of compartments with the mechanism adapted to releasably engage.

13. The method as recited in claim ii, wherein the displaceable cover comprises a rotatable door having a locking mechanism, wherein the method further comprises unlocking the locking mechanism.

14. The method as recited in claim 13, wherein unlocking the locking mechanism comprises remotely unlocking the locking mechanism.

15. The method as recited in claim ii, wherein each of the compartments comprises an aspect ratio greater than 3 to 1.

16. A method of renting kayaks, paddle boards, or canoes, the method comprising:
storing a plurality of kayaks, paddle boards, or canoes for rental to renters in a storage arrangement having a plurality of compartments, each of the compartments having a locking mechanism;
providing a point-of-sale station configured for renter input and payment, the point-of-sale station electrically coupled to the storage arrangement;
receiving input and payment from the renter for one or more desired kayaks, paddle boards, or canoes;
confirming presence of the one or more desired kayaks, paddle boards, or canoes in the storage arrangement;
upon confirmation of payment from the renter, disengaging the locking mechanism allowing the renter to remove the one or more desired kayaks, paddle boards, or canoes from the storage arrangement.

17. The method as recited in claim 16, wherein the storage arrangement having a plurality of compartments comprises a plurality of mechanisms adapted to releasably engage each of the plurality of compartments from an adjacent compartment, and wherein the method further comprises activating at least one of the plurality of mechanisms to releasably engage at least one of the plurality of compartments from another of the plurality of compartment.

18. The method as recited in claim 16, wherein each of the plurality of compartments comprises an aspect ratio greater than 3 to 1.

19. The method as recited in claim 16, wherein the point-of-sale station electrically coupled to the storage arrangement by wire or wirelessly.

20. The method as recited in claim 16, wherein the method further comprises identifying a location of the one or more desired kayaks, paddle boards, or canoes in the storage arrangement.

21. An arrangement for offering kayaks for rental, the arrangement comprising:
a storage arrangement comprising a plurality of storage compartments, each storage compartment adapted to receive at least one kayak and each storage compartment having a locking mechanism; and
a point-sale-station electronically coupled to the storage arrangement, the point-of-sale station configured to receive input from a renter, configured to confirm availability of at least one kayak in the storage arrangement, and configured to disengage the locking mechanism.

22. The arrangement as recited in claim 21, wherein the arrangement further comprising a power supply.

23. The arrangement as recited in claim 22, wherein the power supply comprises at least one photovoltaic panel.

24. The arrangement as recited in claim 21, wherein the point-of-sale station is electrically coupled to the storage arrangement by wire or wirelessly.

25. The arrangement as recited in claim 21, wherein the storage arrangement further comprises an audible or an illuminated beacon.
